(19) United States
(12) Patent Application Publication
(10) Pub. No.: US 2018/0010210 A1
(43) Pub. Date: Jan. 11, 2018

(54) METHOD FOR PRETREATING MAGNESIUM-ALLOY WASTE MATERIAL

(71) Applicant: Heyi Tan, Xiangtan (CN)

(72) Inventors: Heyi TAN, Xiangtan (CN); Lunyuan TANG, Xiangtan (CN)

(73) Assignee: HUNAN S.R.M SCIENCE AND TECHNOLOGY CO., LTD, Xiangtan (CN)

(21) Appl. No.: 15/676,998

(22) Filed: Aug. 14, 2017

Related U.S. Application Data
(63) Continuation of application No. PCT/CN2015/073173, filed on Feb. 16, 2015.

(51) Int. Cl. C22B 26/22; B08B 3/08; B08B 3/02; B08B 3/06; C23G 1/12; B08B 3/14

(52) U.S. Cl. CPC C22B 26/22; C23G 1/12; B08B 3/14; B08B 3/02; B08B 3/06; B08B 3/08

(57) ABSTRACT

A method comprises sorting and removing impurities from magnesium alloy waste material, and cleaning and drying said material, the cleaning being high-pressure rinsing, pickling, and water washing, performed in sequence. The method employs high-pressure rinsing during the pretreatment of magnesium alloy waste material; the cleaning effectiveness is excellent, the effectiveness of the removal of impurities from the surface of the magnesium alloy waste material is much better than in conventional processes, and the amount of clean waste material can exceed 90% of the total amount of processed waste material; the clean magnesium alloy waste material obtained from the pretreatment method may be used as the entire raw materials for casting national-standard alloy ingots, the addition of costly high-purity magnesium is unnecessary, and the amount of alloy raw material that must be added is significantly reduced; during processing, little waste material is lost, costs are low, and efficiency is high.

### CROSS REFERENCE TO RELATED APPLICATIONS

This application is a continuation of PCT/CN2015/073173 filed Feb. 16, 2015, which is incorporated herein by reference.

### BACKGROUND OF THE INVENTION

### 1. Technical Field

The present invention relates to chemical technology, particularly to the method for pretreating waste metal, more particularly to the method for pretreating scrap product of magnesium alloy.

### 2. Description of Related Art

Magnesium and its alloys are advantageous for having small density, good thermal and electric conductivity, excellent damping and electromagnetic shielding effectiveness, and easy to mold and recycle. Thus magnesium and its alloys become popular in modern automotive, electronics and telecommunication industries, and are praised as green engineering material of the 21^{st} century. According to China Nonferrous Metals Industry Association, China produced 769.7 thousand tons of raw magnesium in 2013, namely 10.22% more than the same period in the previous year, and 297.8 thousand tons of magnesium alloy, namely 43.52% more than the same period in the previous year. On one hand, magnesium alloy waste material is always generated in production of magnesium alloy and in processing of magnesium products due to production needs and unavoidable defective workmanship. On the other hand, magnesium alloy products will eventually turn into discarded magnesium alloy products after their service life and for other reasons that prevent them from being usable. Rapid increase in output of magnesium alloy means equally rapid increase in magnesium alloy waste material. Magnesium alloy waste material is highly recoverable and less energy consuming. Its recovery rate is more than 95%, and the energy consumption for recycle is only 5% of that for raw magnesium production. How to recycle magnesium alloy waste material properly is thus a key point that promise significant advancement of magnesium industry for China and other countries all around the world.

Magnesium alloy waste material usually comes from two sources. The first source includes scraps and non-conforming products appearing in casting magnesium alloy, such as feed handle, runner, overflow edge, flash, burrs, cutting scraps and non-conforming castings caused by faulty pouring and post-treatment. In casting, only 30%-40% of the feedstock can be turned into conforming castings. In other words, waste material takes 60-70% of the total feedstock of magnesium alloy. This kind of waste material is relatively clean, and its recycling is usually performed in site or outsourced. The second source is discarded magnesium alloy product including cars' wheel hubs, steering wheels, engine cylinder caps, airplane bodies, airplane skin, computer casing and camera casing, summing more than 200,000 tons/year. While this kind of waste material has good quality, in the products' use, greasiness, dirt and oxide layers can accumulate on its surface, making the treatment challenging, and thus preventing magnesium from effective and valuable recycling.

Recycling waste, discarded material, scrap and swarf of magnesium alloy with rating ensures the grades and full utilization of recycled materials, helping to lower costs. Waste of magnesium and magnesium alloy has eight grades in a draft of international classification standards, as shown in Table A below.

TABLE A
Grades of Waste of Magnesium and Magnesium Alloy

| Grade | Description | Source | Example |
|---|---|---|---|
| 1 | Cleaned and | Produced in die- | Cakes in |
| | sorted waste | casting processes | runners, |
| | | | sprue, burr, |
| | | | flashing and |
| | | | scrapped |
| | | | parts |
| 2 | Cleaned and | Produced in die- | Waste |
| | sorted waste, | casting processes | castings |
| | mixed with | | containing |
| | wooden inclusions | | steel |
| | and steel inclusions | | inclusions |
| 3 | Grade 1 or 2 waste | Produced in die- | |
| | coated or smeared | casting processes | |
| | with paint or | | |
| | greasiness | | |
| 4 | Dry and clean | Produced in die- | Machined |
| | machined debris and | casting processing | debris and |
| | cutting scrap | without lubricator | cutting |
| | | | scrap |
| 5 | Machined debris and | Produced in die-casting | Machined |
| | cutting scrap smeared | processing with oil or | debris and |
| | with oil and water | oil-water emulsion | cutting |
| | | lubricator | scrap |
| 6 | Slag free of salts | Produced in cleaning | Slag |
| | | smelting furnaces | |
| 7 | Slag containing salts | Produced in mold- | Slag |
| | | casting processes | |
| | | under dry condition | |
| 8 | Waste other than those of | | |
| | Grades 1 through 7; alloy | | |
| | of different designations | | |
| | mixed and stored for | | |
| | long time | | |

It can be seen from Table A that, Grades 1-4 magnesium alloy waste material is easy to recycle and reuse, and its recycling is usually performed in site or outsourced. Grades 5-8 magnesium alloy waste material contain more impurities and has less value, so is mainly used to produce non-standard magnesium alloy ingots. Grade 8 magnesium alloy waste material including discarded magnesium alloy products is of high quality and contains relatively less impurity. While the significant obstacle to its effective recycle is the stubborn impurity layer such as greasiness, dirt and oxide layers accumulated on its surface, making the treatment challenging. There has not been a reasonable and effective method for its pretreatment.

In the prior art, recycling of magnesium alloy waste material, and particularly of discarded magnesium alloy products, is less effective. For example, as one approach, waste material is only water rinsed and receives no pretreatment, and after removing some surface impurities from the waste material's surface, it is directly used to produce consumables and non-conforming magnesium alloy ingots, such as firework coloring agents, desulfurizers and non-standard ingots. Another approach involves normal metal treatment where acid/alkali is used. China Patent No. CN 101736160B discloses a method for recovering magnesium alloy low-level waste using repeated pickling as pretreatment. The acid solution used is hydrofluoric acid and the pickling duration is 90 min. Since hydrofluoric acid is highly corrosive to metals, prolonged pickling means serious loss of magnesium alloy waste material. In the prior art, pretreatment for metal and alloy waste material is usually related to corrosive wash (i.e. pickling). During pickling, acid liquid and oxide layers are prevented from contact by greasiness and dirt on the surface of the magnesium alloy waste material, especially the discarded magnesium alloy products, leading to significantly increased pickling time, and in turn increased loss of waste material. In view of this, a known solution is to degrease magnesium alloy waste before pickling (acid pickling or alkaline cleaning) by corrosive wash as pretreatment. For example, China Patent No. CN 101947705A discloses methods for producing magnesium alloy welding wires by adopting magnesium alloy foundry scraps, wherein the pretreatment is performed by degreasing and Corrosive wash. For this purpose, the degreasing solution is mixed solution made of nitric acid of 45%-55% mass concentration and sulfuric acid of 95%-98%. Corrosive wash is performed using saltpeter solution having mass concentration of 15%-25%. The existing method uses highly acid and highly corrosive solution, so is difficult to operate and can lead to serious loss of magnesium alloy waste material.

The two prior-art methods thus have their shortcomings: 1. Simple pretreatment for discarded magnesium alloy products leads to either degraded use or consumptive use of magnesium alloy waste material, where the resulting products are usually disposable and unrecyclable, forming squander of resources and decreasing the product's value; 2. In practical production, the known pretreatment involving degreasing, pickling or their combination is ineffective in cleaning discarded magnesium alloy products because pickling fails to completely remove harmful impurities like greasiness and dirt, and degreasing and/or pickling is relatively irrelevant when it comes to dirt cleaning. Thus, there has no manufacturer using discarded magnesium alloy products as feedstock for producing high quality magnesium alloy products.

To sum up, pretreatment for magnesium alloy waste material, and particularly pretreatment for recycling discarded magnesium alloy products has become a challenging issue and forms a bottleneck to high quality recycling of magnesium alloy waste material. Proper recycle and reuse of the magnesium and magnesium alloy waste material directly affect the reasonableness and sustainability of the magnesium and magnesium alloy industry development.

### SUMMARY OF THE INVENTION

The present invention provides a method for pretreating magnesium alloy waste material, which is highly effective in cleaning stubborn stains on surfaces of magnesium alloy waste material, and in removing dirt and loosen oxide layer from surfaces of magnesium alloy waste material surface, thereby reducing pickling pressure and shortening pickling duration.

For achieving the foregoing objectives, the present invention adopts the following technical schemes.

A method for pretreating magnesium alloy waste material uses pretreatment involving sorting, removing impurities from, cleaning and drying magnesium alloy waste material. The cleaning includes high-pressure cleaning, pickling, and water rinse performed in sequence.

Preferably, the high-pressure cleaning is performed under a pressure of 5-20 MPa, and more preferably 10-15 MPa.

Preferably, the magnesium alloy waste material covers all magnesium alloy waste material as defined in the draft of international classification standards for magnesium and magnesium alloy waste material, and more preferably discarded magnesium alloy products.

Since some discarded magnesium alloy products are bulky and irregular in shape, there are many screws and rubber parts inseparable even through sorting and cleaning. Besides, large magnesium alloy scraps are usually hollow, leading to low packing density. Thus, as another preferred scheme, the magnesium alloy waste material is preferably cut before sorted and having impurities removed therefrom, so as to improve efficiency and relieving requirements about dimensions from the sequent processing equipment.

More preferably, cutting refers to that each large piece of the magnesium alloy waste material are cut into plural small pieces of the magnesium alloy waste material. This is favorable to subsequent processing.

More preferably, each piece of the cut magnesium alloy waste material is smaller than 300 mm in all dimensions, preferably 50-300 mm, and more preferably 100 mm, depending on the size of the magnesium alloy waste material to be processed.

Preferably, sorting and removing impurities refers to screening waste with inseparable screws, rubber, or plastic, waste with organic surface coating, and non-magnesium waste out of the cut waste material. In other words, magnesium alloy waste material containing screws, rubber and plastic are separated out, and the remaining magnesium alloy waste material is reserved for later use.

It should be noted that, in the process of cleaning magnesium alloy waste material with high-pressure water, particularly in the process of removing impurities from grooves of the magnesium alloy waste material, the impact caused by the water is greater than the adhesion between the impurities and the magnesium alloy waste material surface, and thus the bubbles generated by strong water pressure are capable of peeling and flushing away normal impurities. So the high-pressure cleaning is a primary high-pressure cleaning. However, during cleaning, where the magnesium alloy waste material to be treated has its surfaces covered by greasiness or demolding agents, there may be a thick, mixed impurity layer of greasiness and dirt stuck thereon. While the high-pressure water can somehow remove the mixed impurity layer using its pressure, the fact that water and oil are not miscible with each other makes it difficult to fully clean the greasiness or demolding agents adhering to surface of the magnesium alloy waste material without adding any cleaning agent that capable of purging greasiness and demolding agents. Hence, the inventor of the present invention divides high-pressure cleaning into two stages, namely a primary high-pressure cleaning and a secondary high-pressure cleaning. The primary high-pressure cleaning uses high water pressure to remove impurities from the surface of the magnesium alloy waste material, and the secondary high-pressure cleaning uses a cleaning agent combined with high-pressure water so as to easily remove greasiness and demolding agents, and further remove dirt and loosened oxide layers.

More preferably, the cleaning liquid for high-pressure cleaning is water and/or a cleaning agent.

Further, the cleaning agent is a degreasing agent, whose type and concentration may be decided according to the type and amount of greasiness on the waste material's surface. It is preferably a water-based metal degreasing agent. It may additionally or alternatively be other degreasing agents known in the art, such as oil emulsifier or biological decomposer.

Further, the cleaning agent is an acid water-base metal degreasing agent.

Further, the cleaning liquid has a pH value of 5-7.

Further, the cleaning liquid for the primary high-pressure cleaning is water, and the cleaning duration is 10-30 min. The actual duration or temperature of the high-pressure cleaning depend on the severity of greasiness.

Further, the cleaning liquid of the secondary high-pressure cleaning is aqueous solution containing a cleaning agent. The cleaning liquid temperature is 40-70° C., and the cleaning duration is 5-10 min. The actual duration or temperature of the high-pressure cleaning depend on the severity of greasiness.

As a preferred scheme, the magnesium alloy waste material is held in a certain range by a material-holding device during the high-pressure cleaning, so as to prevent from being flushed away and ensure the effect of cleaning. Moreover, the magnesium alloy waste material is allowed to randomly roll in that range for evenly cleaning.

Material-holding device herein is defined as a batch-containing device that holds the magnesium alloy waste material in a certain range and allows the waste material to randomly roll in that range. It not only prevents the waste material from flushed away by the high-pressure water, but also ensures that every part of the waste material is cleaned evenly.

Further, the material holding for the high-pressure cleaning is realized using a meshed drum or other known material-holding methods, depending on the conditions of where the present invention is implemented.

Furthermore, the material-holding device comprises a meshed drum and a motor. The motor is connected to the central shaft installed in the meshed drum. The motor drives the central shaft to rotate and in turn drives the meshed drum to rotate, thereby allowing the magnesium alloy waste material to randomly roll as the meshed drum rotates.

Furthermore, the meshed drum has its mesh diameter smaller than 50 mm. As long as the drum is strong enough to bear the impact pressure from the high-pressure water, the mesh number in a unit area of the drum can be maximized. The actual number may be adjusted according to the conditions of where the present invention is implemented, such as the drum material, the pressure for high-pressure cleaning or the mesh diameter, so as to ensure its cleaning effect by draining the aqueous solution as a product of the high-pressure cleaning timely and thereby allowing the cleaning liquid to impact the waste material directly.

Preferably, the pickling duration is 30-90s, and the pickling liquid's pH value is 1-3. The pickling liquid is one or any mixture solution of hydrochloric acid, nitric acid, sulfuric acid, and oxalic acid. The actual composition depends on degree of oxidation of the magnesium alloy waste material surface.

More preferably, the pickling liquid can be reused for several times. For ensuring that the pickling liquid is in a proper pH range, before every time of reuse, some new acid is added so that the pickling liquid's pH value remains at 1-3. Where Mg²⁺ concentration in the solution is greater than 2.0 mol/L, the pickling liquid is replaced.

More preferably, the waste acid generated after pickling is then recycled after neutralized, filtered, evaporated for crystallization and dried. In particular, the process comprises: using MgO or MgCO₃ to neutralize the waste acid so as to increase its pH value to about 7, filtering, and then removing water from the filtrate, thereby obtaining dry magnesium salts. The obtained dry magnesium salts are of high purity and can be used to prepare magnesium fertilizer.

Further, the filtration is realized using a press filter.

Further, water is removed from the filtrate by evaporating, concentrating, filtering, and drying. Other methods for removing water known in the art may be alternatively used, such as vacuum drying, depending on the conditions of where the present invention is implemented.

Further, the foregoing evaporating, concentrating, filtering, and drying procedures may be realized using a crystallizer and a filter as well as a dryer coming with the crystallizer as a whole suite.

Preferably, water rinse means removing acid liquid and impurities remained on a surface of the magnesium alloy waste material using water,

More preferably, water rinse is performed by means of rinsing or spraying.

Preferably, drying refers to removing water remained on a surface of the cleaned magnesium alloy waste material. At this point, the pretreatment for the magnesium alloy waste material is completed.

More preferably, drying is performed by means of air blowing or hot air drying.

Air blowing is herein defined as an operation that simply uses high-pressure air flow to impact and remove water drops on the surface of the waste material, thereby reducing time and working load of hot air drying. For preventing the waste material from oxidization, use of hot air drying is minimized if not eliminated.

Preferably, the pretreatment further includes a second sorting, e.g. sorting unclean waste material and non-magnesium material out of the dried waste material, so as to obtain clean waste material.

Clean waste material is defined as: magnesium alloy waste material whose contents of harmful elements are allowed by GB standards. Therein, a harmful element refers to any element that can significantly decrease some properties of magnesium alloy (including corrosion resistance, mechanical properties, etc.) even when existing in a minimum amount, such as Si, Cu, Ni, and Fe.

The present invention pioneeringly proposes pretreatment for magnesium alloy waste material that uses high-pressure cleaning to remove all impurities other than dense oxide layers from surfaces of magnesium alloy waste material surface. Greasiness, demolding agents, dust, dirt or loose oxide layers tend to accumulate on surfaces of magnesium alloy waste material, and particularly in grooves on magnesium alloy waste material. When impurities contain greasiness or demolding agents, the surface greasiness layer and the waste material combine closely, and in such case the cleaning liquid for high-pressure cleaning may be aqueous solution containing a cleaning agent. When an acid water-based degreasing agent is used as the cleaning agent, the chemical effects of the degreasing agent and the impact of high-pressure cleaning jointly remove impurities. Additionally, the cleaning liquid when removing greasiness, can slightly react with oxide layers under greasiness, thereby speeding up separation of greasiness, without compromising the effect of the subsequent pickling process. As compared to other cleaning methods before pickling such as ultrasonic cleaning, sand blasting (bead blasting) or other traditional approaches, high-pressure cleaning of the present invention can get much more clean waste material. Besides, high-pressure cleaning is advantageous for its great speed, efficiency, and effectiveness, while it prevents the risk of introducing more impurities by simplifying the entire process. Moreover, the factor determining the cleaning effect on the magnesium alloy waste material surface is the pressure of high-pressure cleaning but not what cleaning liquid it uses. Particularly, to stubborn dirt or impurities tightly attached to magnesium alloy waste material surface, pressure is the key for removing impurities. Meanwhile, the clean waste material obtained in the present invention can be used to produce GB-standard magnesium alloy ingots, without the need of adding expensive high purity magnesium. The present invention is this advantageous for being easy to operate, providing fast reaction, significantly expanding reuse of magnesium alloy waste material, being economic and environmentally friendly, reducing production costs, being suitable for industrial production and thus having promising market value.

To sum up, the present invention has the following advantages:

(1) The present invention can clean magnesium alloy waste material effectively, and the rate of resulting clean waste material is up to 90%;

(2) The impurity-removing rate is high, and the cleaned magnesium alloy waste material may be used as feedstock for casting GB-standard magnesium alloy ingots, without adding expensive high purity magnesium, and the adding amount of alloy materials is significantly decreased;

(3) High-pressure cleaning can effectively remove greasiness and dirt from surfaces of waste material, so as to ensure acid liquid contact oxide layers covered by greasiness and dirt timely during pickling, thereby significantly shortening pickling duration and reducing loss of magnesium alloy waste material during pretreatment;

(4) High-pressure cleaning can bring the cleaning liquid to details of magnesium alloy waste material where is otherwise difficult to clean, and is particularly effective in cleaning grooves;

(5) Whether the impurity-removing medium is water or a degreasing agent, the effect of removing greasy surface impurities is substantively the same (both using impact to peel impurities), and using water as the medium for high-pressure cleaning is much more economic as compared to using a degreasing agent, so it is preferred to use water as the impurity-removing medium in the early stage of high-pressure cleaning for lowered costs;

(6) With high-pressure cleaning that replaces the conventional degreasing process involving alkaline cleaning/pickling and water rinse, it is unlikely that impurities are undesirably introduced due to poor operation, and since high-pressure cleaning can adequately remove stubborn stains from surfaces of magnesium alloy waste material, it can significantly improve utilization of waste material in subsequent processes;

(7) The acid liquid can be recycled and reused, and the generated waste acid can be further used to produce high-purity magnesium salt as feedstock for making magnesium fertilizer, thereby achieving zero discharge of waste pickling liquid, and being economic and environmentally friendly; and

(8) The whole pretreatment flow features small loss of waste material, low costs, and high efficiency, and is suitable for industrialized production.

### DETAILED DESCRIPTION OF THE INVENTION

While the following description will be made referred to examples and comparative examples for detailing the present invention, nothing therein should form limitation to the present invention. Unless stated defiantly in the context, the reagent(s) or equipment mentioned herein are all commercially available and used as instructed by the manuals.

1. Reagent

Hydrochloric acid having its mass fraction of 0.3%-0.5% being prepared into acid hydrochloric dilute having a pH value of about 1.0;

An environmentally friendly degreasing agent, modeled LQ-56-CX-TCL from Landnok Chemical (Guangzhou) Co., Ltd., being prepared with a volume fraction of 1.0% in use;

A magnesium alloy environmentally friendly water-based degreasing agent for ultrasonic use modeled LN-33A-7-45MS from Landnok Chemical (Guangzhou) Co., Ltd., being prepared with a volume fraction of 3.0-5.0% in use.

2. Equipment

A metal crusher modeled PF-J-1000 from Gongyi Xingguang Machinery and Equipment Co., Ltd.;

A heavy-duty hot-water high-pressure cleaning machine modeled 895-1 from Changsha Hongsen Machinery Co. Ltd.;

An ultrasonic cleaning machine modeled HCP-4B72 from Zhuzhou Huasheng Electronic Equipment Co., Ltd.; and

A universal type manual dry sand blasting machine modeled 9060A from Changsha Bai Tong Mechanic Electrical Inc.

### Example 1

The present example uses discarded magnesium alloy products imported by Hunan S.R.M. Technology CO., Ltd. from Sweden with a batch number of 2013-10-05-A as the feedstock for the process. The batch of magnesium alloy waste material sums 5000 tons. Waste having its surface carrying greasiness and demolding agents takes about 10% of the entire batch. The producing steps are as follows:

(1) Cutting: cutting the magnesium alloy waste material using a metal crusher to small waste pieces whose maximum dimension is 100 mm;

(2) Sorting and removing impurities: screening waste material containing inseparable screws, rubber or plastic, waste material with its surface covered by organic coating, and non-magnesium material out from the cut magnesium alloy waste material, and reserving the remaining magnesium alloy waste material for later use;

(3) Primary high-pressure cleaning: performing primary high-pressure cleaning on the magnesium alloy waste material that has been sorted and has impurities removed using a heavy-duty hot-water high-pressure cleaning machine modeled 895-1, wherein the cleaning liquid is water, the pressure is 10 MPa, and the cleaning duration is 20 min;

(4) Secondary high-pressure cleaning: performing secondary high-pressure cleaning on the magnesium alloy waste material that have received the primary high-pressure cleaning using the heavy-duty hot-water high-pressure cleaning machine modeled 895-1, wherein the cleaning liquid is aqueous solution containing an acid water-based metal degreasing agent, in which the aqueous solution prepared according to its formula has a pH value of 5.5, and for the cleaning, the aqueous solution temperature is 55±5° C., the pressure is 10 MPa, and the cleaning duration is 10 min;

(5) Pickling: placing the magnesium alloy waste material that has received the secondary high-pressure cleaning into dilute hydrochloric acid solution having a pH value of 1.0 for pickling, wherein the pickling duration is 40s; before every time of pickling, adding proper amount of acid for ensuring that the pickling liquid is in the pH range, and when Mg²⁺ concentration in the solution is greater than 2.0 mol/L, the pickling liquid is replaced.

(6) Water rinsing: combining rinsing and spraying to remove acid liquid and impurities remained on the surface of the obtained magnesium alloy waste material;

(7) Drying: combining air blowing and hot air drying to remove water remained on the surface of the cleaned magnesium alloy waste material;

(8) Sorting again: sorting unclean waste material and non-magnesium material out of the dried waste material, thereby finalizing pretreatment for the magnesium alloy waste material;

Results of the pretreatment of Example 1 are shown in Table 1:

### Example 2

The present example is similar to Example 1 except that the pressure for primary high-pressure cleaning is 20 MPa.

Results of the pretreatment of Example 2 are shown in Table 1:

### Example 3

The present example is similar to Example 1 except that the pressure for secondary high-pressure cleaning is 20 MPa.

Results of the pretreatment of Example 3 are shown in Table 1:

### Example 4

The present example is similar to Example 1 except that the cleaning liquid for secondary high-pressure cleaning is aqueous solution containing neutral water-based degreasing agent. The aqueous solution prepared according to its formula had a pH value of 7.

Results of the pretreatment of Example 4 are shown in Table 1:

### Example 5

The present example is similar to Example 1 except that the cleaning liquid for secondary high-pressure cleaning is aqueous solution containing alkaline water-based degreasing agent. The aqueous solution prepared according to its formula had a pH value of about 10.

Results of the pretreatment of Example 5 are shown in Table 1:

### Example 6

The materials used in the present example are identical to those for Example 1. The producing steps are as follows:

(1) Cutting: cutting the magnesium alloy waste material using a metal crusher to small waste pieces whose maximum dimension is 100 mm;

(2) Sorting and removing impurities: screening waste material containing inseparable screws, rubber or plastic, waste material with its surface covered by organic coating, and non-magnesium material out from the cut magnesium alloy waste material, and reserving the remaining magnesium alloy waste material for later use;

(3) Primary high-pressure cleaning: performing primary high-pressure cleaning on the magnesium alloy waste material that has been sorted and has impurities removed using a heavy-duty hot-water high-pressure cleaning machine modeled 895-1, wherein the cleaning liquid is water, the pressure is 10 MPa, and the cleaning duration is 20 min;

(4) Pickling: placing the magnesium alloy waste material that has received the high-pressure cleaning into dilute hydrochloric acid solution having a pH value of 1.0 for pickling, wherein the pickling duration is 40s; before every time of pickling, adding proper amount of acid for ensuring that the pickling liquid is in the pH range, and when Mg²⁺ concentration in the solution is greater than 2.0 mol/L, the pickling liquid is replaced.

(5) Water rinsing: combining rinsing and spraying to remove acid liquid and impurities remained on the surface of the obtained magnesium alloy waste material;

(6) Drying: combining air blowing and hot air drying to remove water remained on the surface of the cleaned magnesium alloy waste material;

(7) Sorting again: sorting unclean waste material and non-magnesium material out of the dried waste material, thereby finalizing pretreatment for the magnesium alloy waste material.

Results of the pretreatment of Example 6 are shown in Table 1:

### Comparative Example 1

The materials used in the present example are identical to those for Example 1. The producing steps are as follows:

(1) Cutting: cutting the magnesium alloy waste material using a metal crusher to small waste pieces whose maximum dimension is 100 mm;

(2) Sorting and removing impurities: screening waste material containing inseparable screws, rubber or plastic, waste material with its surface covered by coating, and non-magnesium material out from the cut magnesium alloy waste material, and reserving the remaining magnesium alloy waste material for later use;

(3) Primary high-pressure cleaning: performing primary high-pressure cleaning on the magnesium alloy waste material that has been sorted and has impurities removed, wherein the cleaning liquid is water, the pressure is 10 MPa, and the cleaning duration is 20 min;

(4) Secondary high-pressure cleaning: performing secondary high-pressure cleaning on the magnesium alloy waste material that have received the primary high-pressure cleaning using the heavy-duty hot-water high-pressure cleaning machine modeled 895-1, wherein the cleaning liquid is aqueous solution containing an acid water-based metal degreasing agent, in which the aqueous solution prepared according to its formula has a pH value of 5.5, and for the cleaning, the aqueous solution temperature is 55±5° C., the pressure is 10 MPa, and the cleaning duration is 10 min;

(5) Drying: combining air blowing and hot air drying to remove water remained on the surface of the cleaned magnesium alloy waste material;

(6) Sorting again: sorting unclean waste material and non-magnesium material out of the dried waste material, thereby finalizing pretreatment for the magnesium alloy waste material.

Results of the pretreatment of Comparative Example 1 are shown in Table 1:

### Comparative Example 2

The materials used in the present example are identical to those for Example 1. The producing steps are as follows:

(1) Cutting: cutting the magnesium alloy waste material using a metal crusher to small waste pieces whose maximum dimension is 100 mm;

(2) Sorting and removing impurities: screening waste material containing inseparable screws, rubber or plastic, waste material with its surface covered by coating, and non-magnesium material out from the cut magnesium alloy waste material, and reserving the remaining magnesium alloy waste material for later use;

(3) Pickling: placing the magnesium alloy waste material that has received cleaning into dilute hydrochloric acid solution having a pH value of 1.0 for pickling, wherein the pickling duration is 40s; before every time of pickling, adding proper amount of acid for ensuring that the pickling liquid is in the pH range, and when Mg²⁺ concentration in the solution is greater than 2.0 mol/L, the pickling liquid is replaced.

(4) Water rinsing: combining rinsing and spraying to remove acid liquid and impurities remained on the surface of the obtained magnesium alloy waste material;

(5) Drying: combining air blowing and hot air drying to remove water remained on the surface of the cleaned magnesium alloy waste material;

(6) Sorting again: sorting unclean waste material and non-magnesium material out of the dried waste material, thereby finalizing pretreatment for the magnesium alloy waste material;

Results of the pretreatment of Comparative Example 2 are shown in Table 1:

### Comparative Example 3

The materials used in the present example are identical to those for Example 1. The producing steps are as follows:

(1) Cutting: cutting the magnesium alloy waste material using a metal crusher to small waste pieces whose maximum dimension is 100 mm;

(2) Sorting and removing impurities: screen waste material containing inseparable screws, rubber or plastic, waste material with its surface covered by coating, and non-magnesium material out from the cut magnesium alloy waste material, and reserving the remaining magnesium alloy waste material for later use;

(3) alkali wash: performing degreasing process to the magnesium alloy using alkali wash solution, the proportion of which is: 80 g/L of NaOH, 20 g/L of Na₂CO₃, 10 g/L of Na₃PO₄, 15 g/L of Na₂SiO₃, and the rest being water, and the alkali wash has a washing temperature of 50±5° C. and a washing duration of 2 min;

(4) Pickling: placing the magnesium alloy waste material that has received cleaning into dilute hydrochloric acid solution having a pH value of 1.0 for pickling, wherein the pickling duration is 40s; before every time of pickling, adding proper amount of acid for ensuring that the pickling liquid is in the pH range, and when Mg²⁺ concentration in the solution is greater than 2.0 mol/L, the pickling liquid is replaced.

(5) Water rinsing: combining rinsing and spraying to remove acid liquid and impurities remained on the surface of the obtained magnesium alloy waste material;

(6) Drying: combining air blowing and hot air drying to remove water remained on the surface of the cleaned magnesium alloy waste material;

(7) Sorting again: sorting unclean waste material and non-magnesium material out of the dried waste material, thereby finalizing pretreatment for the magnesium alloy waste material;

Results of the pretreatment of Comparative Example 3 are shown in Table 1:

### Comparative Example 4

The materials used in the present example are identical to those for Example 1. The producing steps are as follows:

(1) Cutting: cutting the magnesium alloy waste material using a metal crusher to waste pieces whose maximum dimension is 100 mm;

(2) Sorting and removing impurities: screen waste material containing inseparable screws, rubber or plastic, waste material with its surface covered by organic coating, and non-magnesium material out from the cut magnesium alloy waste material, and reserving the remaining magnesium alloy waste material for later use;

(3) ultrasonic cleaning: cleaning the magnesium alloy waste material with an ultrasonic cleaning machine, wherein the cleaning liquid has a pH value of 4-6, the ultrasonic wave has a frequency of 28 Hz, and the cleaning temperature is 50±5° C. and the cleaning duration is 30 min;

(4) Pickling: placing the magnesium alloy waste material that has received cleaning into dilute hydrochloric acid solution having a pH value of 1.0 for pickling, wherein the pickling duration is 40s; before every time of pickling, adding proper amount of acid for ensuring that the pickling liquid is in the pH range, and when Mg²⁺ concentration in the solution is greater than 2.0 mol/L, the pickling liquid is replaced.

(5) Water rinsing: combining rinsing and spraying to remove acid liquid and impurities remained on the surface of the obtained magnesium alloy waste material;

(6) Drying: combining air blowing and hot air drying to remove water remained on the surface of the cleaned magnesium alloy waste material;

(7) Sorting again: sorting unclean waste material and non-magnesium material out of the dried waste material, thereby finalizing pretreatment for the magnesium alloy waste material;

Results of the pretreatment of Comparative Example 4 are shown in Table 1:

### Comparative Example 5

The materials used in the present example are identical to those for Example 1. The producing steps are as follows:

(1) Cutting: cutting the magnesium alloy waste material using a metal crusher to waste pieces whose maximum dimension is 100 mm;

(2) Sorting and removing impurities: screen waste material containing inseparable screws, rubber or plastic, waste material with its surface covered by organic coating, and non-magnesium material out from the cut magnesium alloy waste material, and reserving the remaining magnesium alloy waste material for later use;

(3) Sand blasting (bead blasting): processing the magnesium alloy waste material with a sand blasting machine, wherein the sand blasting has a pressure of 1.0 MPa and a duration of 5 min, and the abrasive for sand blasting is cast steel grit.

(4) Pickling: placing the magnesium alloy waste material that has received the secondary high-pressure cleaning into dilute hydrochloric acid solution having a pH value of 1.0 for pickling, wherein the pickling duration is 40s; before every time of pickling, adding proper amount of acid for ensuring that the pickling liquid is in the pH range, when Mg²⁺ concentration in the solution is greater than 2.0 mol/L, the pickling liquid is replaced.

(5) Water rinsing: combining rinsing and spraying to remove acid liquid and impurities remained on the surface of the obtained magnesium alloy waste material;

(6) Drying: combining air blowing and hot air drying to remove water remained on the surface of the cleaned magnesium alloy waste material;

(7) Sorting again: sorting unclean waste material and non-magnesium material out of the dried waste material, thereby finalizing pretreatment for the magnesium alloy waste material;

Results of the pretreatment of Comparative Example 5 are shown in Table 1:

Table 1 shows data of pretreatment experiments obtained from the foregoing examples and comparative examples.

TABLE 1

| | Clean waste | Clean waste |
|---|---|---|
| | material content | material content |
| Composition | before treatment (%) | after treatment (%) |
| Example 1 | 0 | 92 |
| Example 2 | 0 | 94 |
| Example 3 | 0 | 93 |
| Example 4 | 0 | 85 |
| Example 5 | 0 | 84 |
| Example 6 | 0 | 78 |
| Comparative | 0 | 11 |
| Example 1 | | |
| Comparative | 0 | 46 |
| Example 2 | | |
| Comparative | 0 | 50 |
| Example 3 | | |
| Comparative | 0 | 59 |
| Example 4 | | |
| Comparative | 0 | 62 |
| Example 5 | | |

As can be seen from table 1, Examples 1-6 have obviously better pretreating results than Comparative Examples 1-5. Moreover, Examples 1-3 have excellent pretreating results with clean waste material taking up to 90%. According to the table above, by using high-pressure cleaning to remove impurities from magnesium alloy waste material, the resulting rate of clean waste material is much higher than the prior art, thereby providing significant advancement.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A method for pretreating magnesium alloy waste material, involving sorting and removing impurities from, cleaning and drying magnesium alloy waste material, wherein the cleaning includes high-pressure cleaning, pickling, and water rinse performed in sequence.

2. The method of claim 1, wherein the pressure of high-pressure cleaning is 5-20 MPa.

3. The method of claim 1, wherein the pressure of high-pressure cleaning is 10-15 MPa.

4. The method of claim 1, wherein the large magnesium alloy waste material is cut into plural smaller pieces of the magnesium alloy waste material before sorted and having impurities removed therefrom.

5. The method of claim 4, wherein the cut magnesium alloy waste material is smaller than 300 mm in all dimensions.

6. The method of claim 1, wherein sorting and removing impurities refers to screening waste with inseparable screws, rubber, or plastic, waste with surface coating, and non-magnesium waste out of the cut waste material.

7. The method of claim 1, wherein the high-pressure cleaning is a primary high-pressure cleaning.

8. The method of claim 1, wherein the high-pressure cleaning includes a primary high-pressure cleaning and a secondary high-pressure cleaning where the magnesium alloy waste material to be treated has its surfaces covered by greasiness or demolding agents,

9. The method of claim 1, wherein the cleaning liquid for high-pressure cleaning is water and/or a cleaning agent.

10. The method of claim 9, wherein the cleaning agent is a degreasing agent.

11. The method of claim 9, wherein the cleaning agent is a water-base metal degreasing agent.

12. The method of claim 9, wherein the cleaning agent is an acid water-base metal degreasing agent.

13. The method of claim 9, wherein the cleaning liquid for the primary high-pressure cleaning is water.

14. The method of claim 9, wherein the cleaning duration for the primary high-pressure cleaning is 10-30 min.

15. The method of claim 9, wherein the cleaning liquid of the secondary high-pressure cleaning is aqueous solution containing a cleaning agent.

16. The method of claim 9, wherein the cleaning liquid temperature of the secondary high-pressure cleaning is 40-70° C.

17. The method of claim 9, wherein the cleaning duration of the secondary high-pressure cleaning is 5-10 min.

18. The method of claim 1, wherein the pickling liquid is one or any mixture solution of hydrochloric acid, nitric acid, sulfuric acid, and oxalic acid.

19. The method of claim 1, wherein the pickling liquid has a pH value of 1-3, and the pickling duration is 30-90s.

20. The method of claim 1, wherein a treatment performed to the waste acid generated after pickling includes but is not limited to neutralizing, filtering, evaporating for crystallization and drying.
